(19) United States
(12) Patent Application Publication
(10) Pub. No.: US 2009/0122585 A1
(43) Pub. Date: May 14, 2009

(54) STEP-UP/DOWN SWITCHING REGULATOR

(75) Inventor: Shinya Karasawa, Kyoto (JP)

Correspondence Address: CANTOR COLBURN, LLP, 20 Church Street, 22nd Floor, Hartford, CT, 06103, US

(73) Assignee: ROHM CO., LTD., Kyoto (JP)

(21) Appl. No.: 11/995,781

(22) PCT Filed: Jul. 12, 2006
(86) PCT No.: PCT/JP2006/313881

§ 371 Date: Jan. 15, 2008

(30) Foreign Application Priority Data
Jul. 15, 2005 (JP) JP2005-206607

(51) Int. Cl. H02M 7/217

(52) U.S. Cl. 363/127

(57) ABSTRACT

An input voltage Vin is supplied to a first terminal of a control circuit via an inductor connected to outside, and an output capacitor is connected to a second terminal. A switching transistor is provided between the first terminal and ground, and a synchronous rectifier transistor is provided between the first terminal and the second terminal. A first transistor is provided between a back gate of a synchronous rectifier transistor and the first terminal, and a second transistor is provided between the back gate and the second terminal. A switch control unit turns OFF the first transistor and the second transistor at a step-up stop interval; and turns OFF the first transistor and turns ON the second transistor at a step-up operation interval.

### BACKGROUND OF THE INVENTION

1. Field of the Invention

The present invention relates to switching regulators and, more particularly, relates to a step-up or step-down switching regulator of a synchronous rectifying system.

2. Description of the Related Art

Recent various electronic apparatuses such as a mobile phone, a personal digital assistant (referred to as PDA), and a notebook-sized personal computer are mounted with many devices, for example, a light emitting diode (referred to as LED hereinafter) provided as a liquid crystal backlight, a microprocessor, or other analog and digital circuits, which operate at different power supply voltages.

On the other hand, a battery such as a lithium ion battery is mounted on such electronic apparatuses as a power supply. In order to supply a voltage output from the lithium ion battery to devices which operate at different power supply voltages, there is used a direct current (referred to as DC)/DC converter such as a switching regulator in which a battery voltage is stepped up or stepped down.

In a step-up or step-down switching regulator, there exist a system using a rectifying diode (referred to as diode rectifying system hereinafter) and a system using a synchronous rectifier transistor (referred to as synchronous rectifying system hereinafter) in place of a diode. In the former case, there is an advantage in that high efficiency can be obtained when a load electric current flowing to a load is small; however, since a diode is required on the outside of a control circuit in addition to an inductor and an output capacitor, a circuit area becomes large. In the latter case, efficiency when a current supplied to a load is small is inferior to the former case; however, since the transistor is used in place of the diode, integration can be made in the inside of a large scale integrated circuit (referred to as LSI); and consequently, reduction in size is possible as a circuit area including peripheral components. In electronic apparatuses such as a mobile phone which is required for reduction in size, there are many cases where a switching regulator using a rectifier transistor (referred to as switching regulator of synchronous rectifying system hereinafter) is used.

In this case, the step-up switching regulator of the synchronous rectifying system has a path in which the synchronous rectifier transistor and the inductor are connected in series between an input terminal to which a battery voltage or the like is input and an output terminal from which a voltage after step-up (referred to as output voltage hereinafter) is output. In the case where a P-channel metal oxide semiconductor field effect transistor (referred to as P-channel MOSFET) is used in the synchronous rectifier transistor and a back gate thereof is connected to a source (or drain), there is a problem in that a current flows to a load via a body diode (parasitic diode) between the back gate and the drain (or source) and the inductor even in a state when step-up operation stops by turning OFF the synchronous rectifier transistor.

Patent document 1: Japanese Patent Application (Laid open) No. 2004-32875

Patent document 2: Japanese Patent Application (Laid open) No. 2002-252971

In order to block the current flowing to the load via the synchronous rectifier transistor and the inductor when stopping step-up operation, it is conceivable that a DC preventing transistor is provided on the current path as a switching element. However, the DC preventing transistor serves as a resistance element in step-up operation; and therefore, it causes a loss in electric power. In order to reduce the electric power loss due to the DC preventing transistor, the size of the transistor needs to be increased to reduce ON-resistance; however, there arises a problem in that it causes an increase in a circuit area.

### SUMMARY OF THE INVENTION

The present invention has been made in view of such problem, and a general purpose of the present invention is to provide a switching regulator of a synchronous rectifying system capable of blocking a current that flows when step-up/down operation is stopped without providing a DC preventing transistor.

An embodiment the present invention relates to a control circuit for a step-up switching regulator of a synchronous rectifying system. The control circuit includes: a first terminal to which an input voltage is supplied via an inductor connected to outside; a second terminal to which an output capacitor is connected; a switching transistor provided between the first terminal and ground; a synchronous rectifier transistor provided between the first terminal and the second terminal; a first transistor provided between a back gate of the synchronous rectifier transistor and the first terminal; a second transistor provided between the back gate of the synchronous rectifier transistor and the second terminal; and a switch control unit which performs ON/OFF control of the first and second transistors.

According to the embodiment, the first and second transistors are provided in place of connecting the back gate of the synchronous rectifier transistor to a source or a drain, and ON/OFF control of the two transistors are performed; and accordingly, a current that flows via the back gate of the synchronous rectifier transistor can be controlled. As a result, when step-up is stopped, it is possible to prevent an unnecessary current from flowing and to prevent a voltage from appearing at an output terminal even a DC preventing transistor is not provided in series to the inductor.

The switch control unit may turn OFF the first transistor and the second transistor at a step-up stop interval of the step-up switching regulator which is driven by the present control circuit; and may turn OFF the first transistor and turn ON the second transistor at a step-up operation interval.

Both the first transistor and the second transistor are turned OFF at the step-up stop interval; and accordingly, it is possible to block a current path via the back gate of the synchronous rectifier transistor. In addition, the second transistor is turned ON at the step-up operation interval; and accordingly, it is possible to generate the current path via the back gate of the synchronous rectifier transistor.

The switch control unit may gradually turn ON the second transistor in a state where the first transistor is turned ON at a start-up interval transiting from an operation stop state to a step-up operation state of the step-up switching regulator.

In this case, it is possible to prevent the synchronous rectifier transistor from causing latch-up.

Another embodiment of the present invention relates to a control circuit for a step-down switching regulator of a synchronous rectifying system. The control circuit includes: a first terminal which outputs a switching voltage to an inductor connected to outside; a second terminal to which an input voltage is supplied from the outside; a switching transistor provided between the first terminal and the second terminal; a synchronous rectifier transistor provided between the first terminal and ground; a first transistor provided between a back gate of the switching transistor and the first terminal; a second transistor provided between the back gate of the switching transistor and the second terminal; and a switch control unit which performs ON/OFF control of the first and second transistors.

According to the embodiment, the first and second transistors are provided in place of connecting the back gate of the switching transistor to a drain or a source, and ON/OFF control of the two transistors are performed; and accordingly, a current that flows via the back gate of the switching transistor can be controlled.

The switch control unit may turn OFF the first transistor and the second transistor at a step-down stop interval of the step-down switching regulator which is driven by the present control circuit; and may turn OFF the first transistor and turn ON the second transistor at a step-down operation interval.

Both the first transistor and the second transistor are turned OFF at the step-down stop interval; and accordingly, it is possible to block a current path via the back gate of the switching transistor. In addition, the second transistor is turned ON at the step-down operation interval; and accordingly, it is possible to generate the current path via the back gate of the switching transistor.

The switch control unit may gradually turn ON the second transistor in a state where the first transistor is turned OFF at a start-up interval transiting from an operation stop state to a step-down operation state of the step-down switching regulator.

Still another embodiment of the present invention relates to a control circuit for a switching regulator which can switch a step-up mode or a step-down mode. The control circuit includes: a first switching transistor which serves as a switching transistor at the step-up mode, and serves as a synchronous rectifier transistor at the step-down mode; a second switching transistor which serves as a synchronous rectifier transistor at the step-up mode, and serves as a switching transistor at the step-down mode; a first transistor provided between a back gate and a drain of the second switching transistor; a second transistor provided between the back gate and a source of the second switching transistor; and a switch control unit which performs ON/OFF control of the first and second transistors.

According to the embodiment, the switch control unit can suitably switch ON and OFF states of the first and second transistors in the step-up mode and the step-down mode.

The switching transistor, the synchronous rectifier transistor, the first transistor, the second transistor, and the switch control unit may be integrally integrated on one semiconductor substrate. In addition, the “integration” in this case includes the case where all of circuit constituent elements are formed on the semiconductor substrate, and the case where major constituent elements in the circuit are integrally integrated; and a certain resistor, capacitor, or the like may be provided on the outside of the semiconductor substrate for adjusting a circuit constant.

Another embodiment of the present invention relates to a step-up switching regulator. The switching regulator includes: a control circuit described above; an inductor whose one end is connected to the first terminal of the control circuit, and an input voltage is applied to the other end; and an output capacitor whose one end is connected to the second terminal of the control circuit, and the other end is grounded, wherein the voltage at the one end of the output capacitor is output.

According to the embodiment, ON/OFF control of the first and second transistors is suitably performed by the switch control unit; and accordingly, a current that flows via a back gate of the synchronous rectifier transistor can be controlled; and it is possible to prevent an input voltage from appearing at one end of the output capacitor or to prevent a current from flowing to a load when step-up is stopped.

Still another embodiment of the present invention relates to a step-down switching regulator. The step-down switching regulator includes: an output capacitor whose one end is grounded; an inductor whose one end is connected to the other end of the output capacitor; and an above described control circuit which supplies the switching voltage to the other end of the inductor, wherein the voltage at the other end of the output capacitor is output.

According to the embodiment, ON/OFF control of the first and second transistors is performed; and accordingly, a current that flows via a back gate of the switching transistor can be controlled.

Still another embodiment of the present invention relates to an electronic apparatus. The electronic apparatus includes: a battery; and an above described switching regulator which steps up or steps down a voltage of the battery.

According to the embodiment, a current that flows via a back gate of the synchronous rectifier transistor or the switching transistor is controlled; and accordingly, an inrush current at power-on can be suppressed. In addition, a DC preventing transistor does not need to be provided; and therefore, a loss due to resistance can be reduced and a circuit area can be reduced.

It is to be noted that any arbitrary combination or rearrangement of the above-described structural components and so forth is effective as and encompassed by the present embodiments.

Moreover, this summary of the invention does not necessarily describe all necessary features so that the invention may also be a sub-combination of these described features.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a circuit diagram showing a configuration of a step-up switching regulator according to a first embodiment;

FIG. 2 is a time chart showing an operation state of the step-up switching regulator shown in FIG. 1;

FIG. 3 is a circuit diagram showing a configuration of a step-up switching regulator according to a second embodiment;

FIG. 4 is a time chart showing an operation state of the step-down switching regulator shown in FIG. 3;

FIG. 5 is a circuit diagram showing a configuration of a control circuit according to a third embodiment; and

FIG. 6 is a block diagram showing a configuration of an electronic apparatus in which the control circuits shown in FIG. 1, FIG. 3, and FIG. 5 are suitably used.

### DETAILED DESCRIPTION OF THE INVENTION

The invention will now be described based on preferred embodiments which do not intend to limit the scope of the present invention but exemplify the invention. All of the features and the combinations thereof described in the embodiment are not necessarily essential to the invention.

### First Embodiment

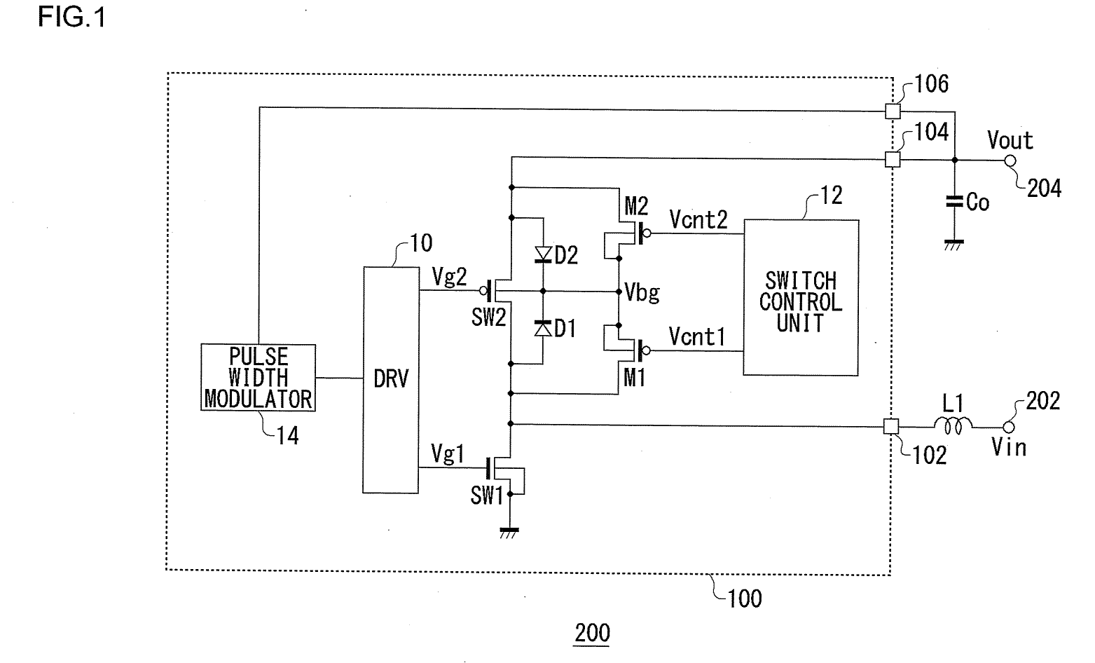

A first embodiment according to the present invention relates to a step-up switching regulator of a synchronous rectifying system. FIG. 1 is a circuit diagram showing a configuration of a step-up switching regulator 200 according to the first embodiment. The step-up switching regulator 200 is a switching regulator of the synchronous rectifying system including a control circuit 100, an inductor L1, and an output capacitor Co.

An input voltage Vin is applied to an input terminal 202. The step-up switching regulator 200 according to the present embodiment steps up the input voltage Vin at a predetermined step-up rate, and outputs an output voltage Vout from an output terminal 204.

The inductor L1 is connected between a first terminal 102 of the control circuit 100 and the input terminal 202 of the step-up switching regulator 200. The input voltage Vin is supplied to the first terminal 102 via the inductor L1. The output capacitor Co is connected between the second terminal 104 and ground.

The control circuit 100 includes a switching transistor SW1, a synchronous rectifier transistor SW2, a first transistor M1, a second transistor M2, a driver circuit 10, a switch control unit 12, and a pulse width modulator 14; and these are integrated on one semiconductor substrate.

The switching transistor SW1 is an N-channel metal oxide semiconductor field effect transistor (referred to as N channel MOSFET), a drain is connected to the first terminal 102, and a source is grounded. Furthermore, the synchronous rectifier transistor SW2 is a P-channel MOSFET, a drain is connected to the first terminal 102, and a source is connected to the second terminal 104. A first gate control signal Vg1 and a second gate control signal Vg2 output from the driver circuit 10 are input to gates of the switching transistor SW1 and the synchronous rectifier transistor SW2.

The output voltage Vout of the step-up switching regulator 200 is feedback input to a voltage feedback terminal 106 of the control circuit 100. The fed-back output voltage Vout is input to the pulse width modulator 14. The pulse width modulator 14 generates a pulse width modulation signal (referred to as PWM signal Vpwm hereinafter) in which a time ratio between a high level and a low level, that is, a duty ratio changes. The duty ratio of the PWM signal Vpwm is controlled so that the output voltage Vout approaches to a predetermined reference voltage.

The driver circuit 10 generates the first gate control signal Vg1 and the second gate control signal Vg2 on the basis of the PWM signal Vpwm output from the pulse width modulator 14, and outputs the same to the gates of the switching transistor SW1 and the synchronous rectifier transistor SW2, respectively. The switching transistor SW1 and the synchronous rectifier transistor SW2 alternatively repeat ON/OFF cycles on the basis of the duty ratio of the PWM signal Vpwm.

As shown in FIG. 1, there exists a body diode (parasitic diode) D1 or D2 between a back gate and the drain or between the back gate and the source of the synchronous rectifier transistor SW2; and hereinafter, the former is referred to as a first body diode D1 and the latter is referred to as a second body diode D2, respectively. Usually, the back gate of the P-channel MOSFET is used by being connected to the source; and therefore, both ends of the second body diode D2 are used in a short-circuited state. In this case, as described above, when step-up is stopped, a current flows from the input terminal 202 to the output terminal 204 via the first body diode D1.

On the other hand, in the control circuit 100 according to the present embodiment, the first transistor M1 and the second transistor M2 are provided in place of connecting the back gate to the source of the synchronous rectifier transistor SW2.

The first transistor M1 is a P-channel MOSFET, and is provided between a back gate of the switching transistor SW1 and the first terminal 102. That is, a source of the first transistor M1 is connected to the first terminal 102, and a drain is connected to the back gate of the synchronous rectifier transistor SW2. The second transistor M2 is also a P-channel MOSFET, and is provided between the back gate of the switching transistor SW1 and the second terminal 104. That is, a source of the second transistor M2 is connected to the back gate of the synchronous rectifier transistor SW2, and a drain is connected to the second terminal 104.

The switch control unit 12 generates a first control signal Vcnt1 and a second control signal Vcnt2 in response to an operation state of the step-up switching regulator 200, controls gate voltages of the first transistor M1 and the second transistor M2, and performs ON/OFF control respectively. In the present embodiment, the step-up switching regulator 200 operates in three states: a step-up stop state which stops electric power supply to a load by stopping a step-up operation; a step-up operation state which supplies a predetermined output voltage Vout to the load by the step-up operation; and a start-up state which responds to a transition interval from the step-up stop state to the step-up operation state.

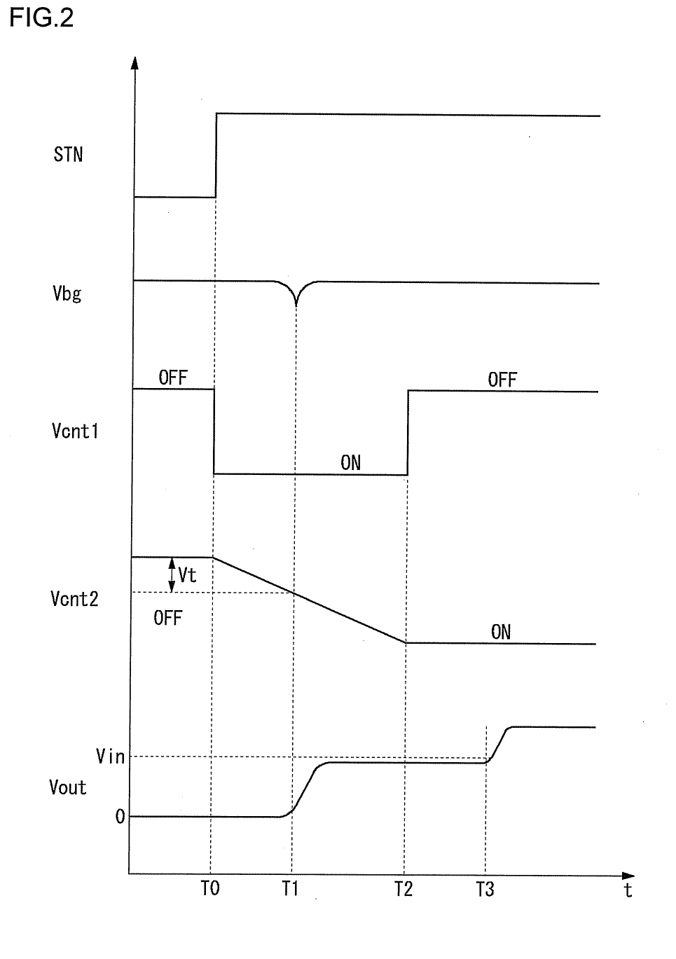

The operation of the thus configured step-up switching regulator 200 will be described. FIG. 2 is a time chart showing an operation state of the step-up switching regulator 200; and for simplicity of explanation, the drawing shows a vertical axis and a horizontal axis in appropriately enlarged or contracted representation.

Before time T0, the step-up switching regulator 200 is in a step-up stop state. At this time, a switch control unit 12 makes a first control signal Vcnt1 and a second control signal Vcnt2 be a high level to turn OFF both a first transistor M1 and a second transistor M2. When both the first transistor M1 and the second transistor M2 are turned OFF, a current does not flow to a first body diode D1 and a second body diode D2 of a synchronous rectifier transistor SW2. As a result, a current path between an input terminal 202 and an output terminal 204 via a back gate of the synchronous rectifier transistor SW2 can be blocked; and therefore, it is possible to prevent a current from flowing to a load, or to prevent a voltage, which is near an input voltage Vin, from appearing at an output terminal 204. At before the time T0, a potential Vbg of the back gate of the synchronous rectifier transistor SW2 is at a high level.

At the time T0, a standby signal STB (not shown in FIG. 1) becomes from a low level to a high level; and start-up of the step-up switching regulator 200 is directed. When the standby signal STB becomes the high level, the switch control unit 12 makes the first control signal Vcnt1 be a low level to turn ON the first transistor M1. Furthermore, the switch control unit 12 makes the second control signal Vcnt2 reduce gradually from the high level to a low level. After that, when the second control signal Vcnt2 reduces and a voltage between a gate and a source of the second transistor M2 becomes larger than a threshold voltage Vt, the second transistor M2 turns ON. The second transistor M2 gradually turns ON; and accordingly, an output voltage Vout appeared at a second terminal 104 rises to near the input voltage Vin applied to the input terminal 202.

As described above, the step-up switching regulator 200 according to the present embodiment gradually turns ON the second transistor M2 at start-up; and accordingly, generation of an inrush current can be suppressed.

When the start-up has been completed at time T2, the switch control unit 12 makes the first control signal Vcnt1 be the high level to turn OFF the first transistor M1. After that, switching operations of the switching transistor SW1 and the synchronous rectifier transistor SW2 are started by a pulse width modulator 14 and a driver circuit 10 at time T3. When a step-up operation is started at the time T3, the output voltage Vout rises to a predetermined reference voltage.

In the step-up switching regulator 200 according to the present embodiment, the first transistor M1 is in OFF state and the second transistor M2 is in ON state during the step-up operation. This is a circuit state which is the same as a state where a back gate of a P-channel MOSFET is connected to a source; and therefore, the step-up operation can be suitably performed. In addition, the step-up operation is started at the time T3 after a predetermined interval has been passed since the start-up started at the time T0; and accordingly, it is possible to prevent the switching transistor SW1 from causing latch-up during reducing a back gate voltage Vbg of the switching transistor SW1.

### Second Embodiment

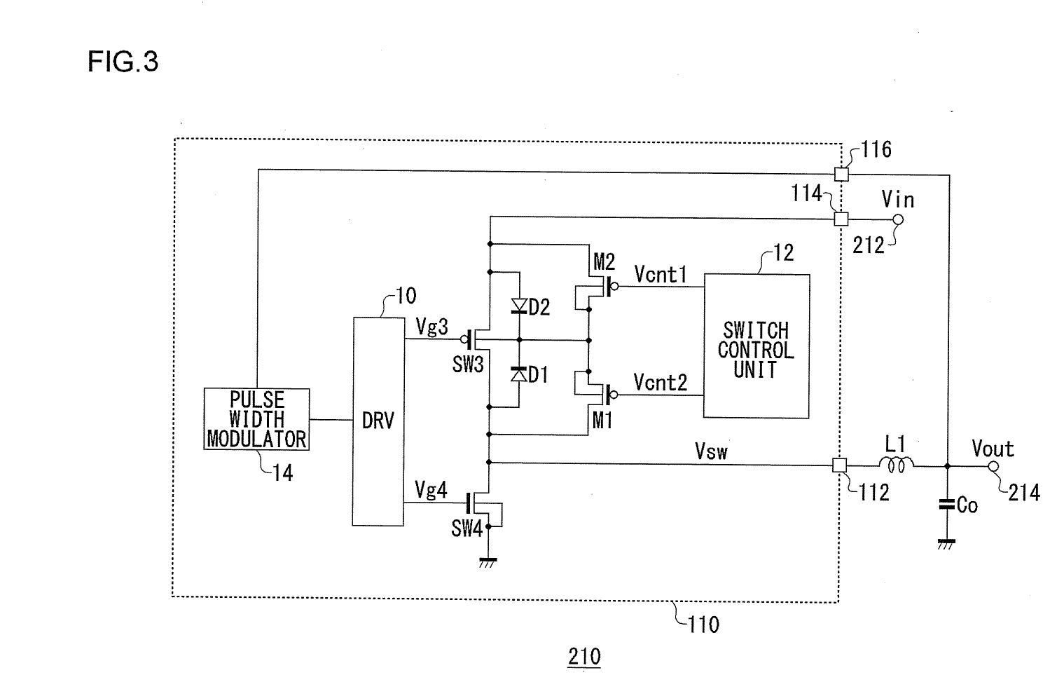

A second embodiment relates to a step-down switching regulator 210 of a synchronous rectifying system. FIG. 3 is a circuit diagram showing a configuration of the step-down switching regulator 210 according to the second embodiment. The step-down switching regulator 210 is a switching regulator of the synchronous rectifying system including a control circuit 110, an inductor L1, and an output capacitor Co. In the same drawing, the same reference numerals are given to those identical or equivalent to constitutional elements in FIG. 1; and their description will be arbitrarily omitted.

An input voltage Vin is applied to an input terminal 212. The step-down switching regulator 210 according to the present embodiment steps down the input voltage Vin, and outputs an output voltage Vout from an output terminal 214. The inductor L1 is connected between a first terminal 112 of the control circuit 110 and the output terminal 214 of the step-down switching regulator 210. The output capacitor Co is connected between the output terminal 214 and ground. The first terminal 112 outputs a switching voltage Vsw to the inductor L1 connected to outside. The input voltage Vin is supplied to the second terminal 114 from the outside.

The control circuit 110 includes a switching transistor SW3, a synchronous rectifier transistor SW4, a first transistor M1, a second transistor M2, a driver circuit 10, a switch control unit 12, and a pulse width modulator 14.

The synchronous rectifier transistor SW4 is an N-channel MOSFET; and a drain is connected to the first terminal 112, and a source is grounded. Furthermore, the switching transistor SW3 is a P-channel MOSFET; and a drain is connected to the first terminal 112, and a source is connected to the second terminal 114. A first gate control signal Vg3 and a second gate control signal Vg4 output from the driver circuit 10 are input to gates of the switching transistor SW3 and the synchronous rectifier transistor SW4.

The output voltage Vout of the step-down switching regulator 210 is feedback input to a voltage feedback terminal 116 of the control circuit 110. The fed-back output voltage Vout is input to the pulse width modulator 14. The pulse width modulator 14 and the driver circuit 10 drive the switching transistor SW3 and the synchronous rectifier transistor SW4 on the basis of the fed-back output voltage Vout.

In the control circuit 110 according to the present embodiment, the first transistor M1 and the second transistor M2 are provided in place of connecting a back gate to a source of a switching transistor SW3.

The first transistor M1 is a P-channel MOSFET, and is provided between a back gate of the switching transistor SW3 and the first terminal 112. That is, a source of the first transistor M1 is connected to the first terminal 112, and a drain is connected to the back gate of the switching transistor SW3.

The second transistor M2 is also a P-channel MOSFET, and is provided between the back gate of the switching transistor SW3 and the second terminal 114. That is, a source of the second transistor M2 is connected to the back gate of the switching transistor SW3, and a drain is connected to the second terminal 114.

The switch control unit 12 generates a first control signal Vcnt1 and a second control signal Vcnt2 in response to an operation state of the step-down switching regulator 210, controls gate voltages of the first transistor M1 and the second transistor M2, and performs ON/OFF control respectively. In the present embodiment, the step-down switching regulator 210 operates in three states: a step-down stop state which stops electric power supply to a load by stopping a step-down operation; a step-down operation state which supplies a predetermined output voltage Vout to the load by the step-down operation; and a start-up state which responds to a transition interval from the step-down stop state to the step-down operation state.

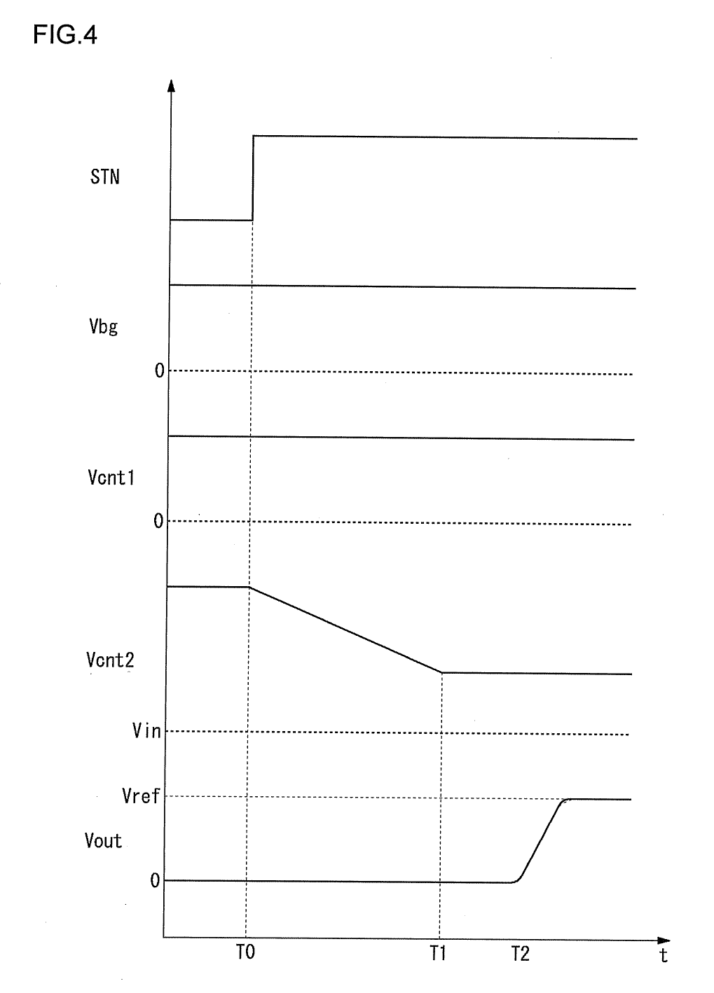

The operation of the thus configured step-down switching regulator 210 will be described. FIG. 4 is a time chart showing an operation state of the step-down switching regulator 210; and for simplicity of explanation, the drawing shows a vertical axis and a horizontal axis in appropriately enlarged or contracted representation.

Before time T0, the step-down switching regulator 210 is in a step-down stop state. At this time, a switch control unit 12 makes a first control signal Vcnt1 and a second control signal Vcnt2 be a high level to turn OFF both a first transistor M1 and a second transistor M2. When both the first transistor M1 and the second transistor M2 are turned OFF, a current does not flow to a first body diode D1 and a second body diode D2 of the switching transistor SW3. At before the time T0, a potential Vbg of a back gate of the synchronous rectifier transistor SW4 is at a high level.

At the time T0, a standby signal STB (not shown in FIG. 3) becomes from a low level to a high level; and start-up of the step-down operation of the step-down switching regulator 210 is directed. When the standby signal STB becomes the high level, the switch control unit 12 keeps the first control signal Vcnt1 at the high level, and gradually reduces the second control signal Vcnt2 from the high level to a low level. At this time, a back gate voltage Vbg of the switching transistor SW3 is being kept at the high level.

As described above, the step-down switching regulator 210 according to the present embodiment turns OFF the first transistor M1 at start-up; and accordingly, it is possible to prevent an input voltage Vin from appearing in a switching voltage Vsw.

The start-up is completed at time T1. After that, switching operations of the switching transistor SW3 and a synchronous rectifier transistor SW4 are started by a pulse width modulator 14 and a driver circuit 10 at time T2. When the step-down operation is started at the time T2, an output voltage Vout rises to a predetermined reference voltage Vref.

In the step-down switching regulator 210 according to the present embodiment, the first transistor M1 is in the OFF state and the second transistor M2 is in an ON state during the step-down operation. This is a circuit state which is the same as a state where a back gate of a P-channel MOSFET is connected to a source; and therefore, the step-down operation can be suitably performed.

### Third Embodiment

The control circuit 100 shown in FIG. 1 and the control circuit 110 shown in FIG. 3 are equivalent in circuit configuration; and arrangement of the externally provided inductor L1 and output capacitor Co and appearing positions of the input voltage Vin and the output voltage Vout are different. Consequently, in a third embodiment, the control circuit 100 shown in FIG. 1 and the control circuit 110 shown in FIG. 3 are used as a control circuit for a switchable step-up/down switching regulator.

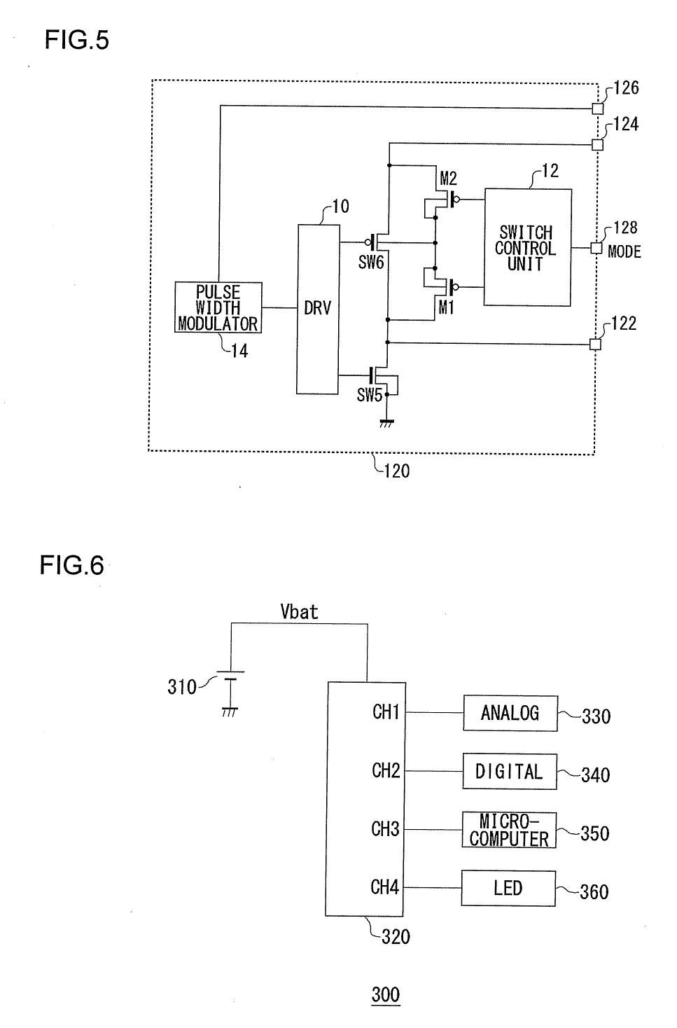

FIG. 5 is a circuit diagram showing a configuration of a control circuit 120 according to the third embodiment. The control circuit 120 includes a first switching transistor SW5, a second switching transistor SW6, a first transistor M1, a second transistor M2, a driver circuit 10, a switch control unit 12, and a pulse width modulator 14. The first switching transistor SW5 serves as a switching transistor at a step-up mode; and serves as a synchronous rectifier transistor at a step-down mode. Furthermore, the second switching transistor SW6 serves as a synchronous rectifier transistor at a step-up mode; and serves as a switching transistor at a step-down mode. Each of the first transistor M1 and the second transistor M2 is a P-channel MOSFET. An output voltage is fed back to a voltage feedback terminal 126. A first terminal 122 corresponds to the first terminal 102 shown in FIG. 1, or to the first terminal 112 shown in FIG. 3; and a second terminal 124 corresponds to the second terminal 104 shown in FIG. 1, or to the second terminal 114 shown in FIG. 3.

The first transistor M1 is provided between a back gate and a drain of the second switching transistor SW6. Furthermore, the second transistor M2 is provided between the back gate and a source of the second switching transistor.

A mode designation signal MODE which designates a step-up mode or a step-down mode is input to a mode terminal 128. The mode designation signal MODE is input to the switch control unit 12. The switch control unit 12 judges whether or not it should be operated in a step-up mode or in a step-down mode according to the mode designation signal MODE; and performs ON/OFF control of the first transistor M1 and the second transistor M2 on the basis of the judged result. The switch control unit 12 controls the first transistor M1 and the second transistor M2 by the system described in the first embodiment in the step-up mode; and controls the first transistor M1 and the second transistor M2 by the system described in the second embodiment in the step-down mode.

According to the thus configured control circuit 120, the first transistor M1 and the second transistor M2 can be controlled even when a user uses as a control circuit of either of the step-up switching regulator or the step-down switching regulator.

FIG. 6 is a block diagram showing a configuration of an electronic apparatus 300 in which the control circuits 100, 110, and 120 shown in FIG. 1, FIG. 3, and FIG. 5 are suitably used. The electronic apparatus 300 is, for example, a digital still camera or a mobile phone terminal; and includes a battery 310, a power supply apparatus 320, an analog circuit 330, a digital circuit 340, a microcomputer 350, and LED 360.

The battery 310 is, for example, a lithium ion battery; and outputs approximately 3 to 4 V as a battery voltage Vbat. The analog circuit 330 includes a circuit block which stably operates at a power supply voltage Vcc of approximately 3.4 V. Furthermore, the digital circuit 340 includes various types of digital signal processors (referred to as DSP), and includes a circuit block which stably operates at a power supply voltage Vdd of approximately 3.4 V. The microcomputer 350 is a block which overall controls the entire electronic apparatus 300, and operates at a power supply voltage of 1.5 V. The LED 360 includes LED of a three color RGB (light emitting diode) and is used for a liquid crystal backlight and illumination; and a driving voltage of not lower than 4 V is required for driving the same.

The power supply apparatus 320 is a multiple channel switching power supply; includes a switching regulator which steps up or steps down the battery voltage Vbat for each channel if required; and supplies a power supply voltage suitable for the analog circuit 330, the digital circuit 340, the microcomputer 350, and the LED 360.

A plurality of the control circuits 120 shown in FIG. 5 according to the present embodiment are arranged in parallel to configure a multi-channel control circuit; and accordingly, it is possible to suitably use the multi-channel control circuit for such power supply apparatus 320. That is, in the case where a four channel control circuit is configured; a third channel CH3 which supplies the power supply voltage to the microcomputer 350 maybe operated as a step-down mode; and a fourth channel CH4 which supplies the power supply voltage to the LED 360 may be operated as a step-up mode.

It is to be understood to those skilled in the art that the configuration of the above embodiments is made by way of example, various modifications are possible in the combination of their respective constituent elements and respective treatment processes, and such modifications fall within the scope of the present invention.

In the embodiments, there is described the case where the control circuit 100 and the like are integrally integrated in one LSI; however, the present invention is not limited to this, certain constituent elements may be provided on the outside of the LSI as a discrete element or a chip component, or may be configured by a plurality of LSIs.

In addition, in the present embodiments, setting of logical values of the high level and the low level is an example; and it is possible to change freely by appropriately inverting by an inverter or the like.

While the preferred embodiments of the present invention have been described using specific term, such description is for illustrative purposes only, and it is to be understood that changes and variations may be made without departing from the spirit or scope of the appended claims.

What is claimed is:

1. A control circuit for a step-up switching regulator of a synchronous rectifying system, said control circuit comprising:
a first terminal to which an input voltage is supplied via an inductor connected to outside;
a second terminal to which an output capacitor is connected;
a switching transistor provided between said first terminal and ground;
a synchronous rectifier transistor provided between said first terminal and said second terminal;
a first transistor provided between a back gate of said synchronous rectifier transistor and said first terminal;
a second transistor provided between the back gate of said synchronous rectifier transistor and said second terminal; and
a switch control unit which performs ON/OFF control of said first and second transistors.

2. The control circuit according to claim 1, wherein
said switch control unit turns OFF said first transistor and said second transistor at a step-up stop interval of said step-up switching regulator which is driven by the control circuit and turns OFF said first transistor and turns ON said second transistor at a step-up operation interval.

3. The control circuit according to claim 2, wherein
said switch control unit gradually turns ON said second transistor in a state where said first transistor is turned ON at a start-up interval transiting from a step-up stop state to a step-up operation state of said step-up switching regulator.

4. The control circuit according to claims 1, wherein
said synchronous rectifier transistor, said first transistor, and said second transistor are a P-channel metal oxide semiconductor field effect transistor (referred to as P-channel MOSFET).

5. A control circuit for a step-down switching regulator of a synchronous rectifying system, said control circuit comprising:
a first terminal which outputs a switching voltage to an inductor connected to outside;
a second terminal to which an input voltage is supplied from outside;
a switching transistor provided between said first terminal and said second terminal;
a synchronous rectifier transistor provided between said first terminal and ground;
a first transistor provided between a back gate of said switching transistor and said first terminal;
a second transistor provided between the back gate of said switching transistor and said second terminal; and
a switch control unit which performs ON/OFF control of said first and second transistors.

6. The control circuit according to claim 5, wherein
said switch control unit turns OFF said first transistor and said second transistor at a step-down stop interval of said step-down switching regulator which is driven by the control circuit and turns OFF said first transistor and turns ON said second transistor at a step-down operation interval.

7. The control circuit according to claim 6, wherein
said switch control unit gradually turns ON said second transistor in a state where said first transistor is turned OFF at a start-up interval transiting from a step-down stop state to a step-down operation state of said step-down switching regulator.

8. The control circuit according to claims 5, wherein
said switching transistor, said first transistor, and said second transistor are a P-channel metal oxide semiconductor field effect transistor (referred to as P-channel MOSFET).

9. A control circuit for a switching regulator which can switch a step-up mode or a step-down mode, said control circuit comprising:
a first switching transistor which serves as a switching transistor at the step-up mode, and serves as a synchronous rectifier transistor at the step-down mode;
a second switching transistor which serves as a synchronous rectifier transistor at the step-up mode, and serves as a switching transistor at the step-down mode;
a first transistor provided between a back gate and a drain of said second switching transistor;
a second transistor provided between the back gate and a source of said second switching transistor; and
a switch control unit which performs ON/OFF control of said first and second transistors.

10. The control circuit according to claims 1, wherein
said switching transistor, said synchronous rectifier transistor, said first transistor, said second transistor, and said switch control unit are integrally integrated on one semiconductor substrate.

11. A step-up switching regulator comprising:
a control circuit according to claim 1;
an inductor whose one end is connected to said first terminal of said control circuit, and an input voltage is applied to the other end; and
an output capacitor whose one end is connected to said second terminal of said control circuit, and the other end is grounded,
wherein a voltage at the one end of said output capacitor is output.

12. An electronic apparatus comprising:
a battery; and
a switching regulator according to claim 11 in which a voltage of said battery is stepped up or stepped down.

13. A step-down switching regulator comprising:
an output capacitor whose one end is grounded;
an inductor whose one end is connected to the other end of said output capacitor; and
a control circuit according to 5 which supplies said switching voltage to the other end of said inductor,
wherein a voltage at the other end of said output capacitor is output.

14. An electronic apparatus comprising:
a battery; and
a switching regulator according to claim 13 which steps up or steps down a voltage of the battery.

15. The control circuit according to claim 5, wherein said switching transistor, said synchronous rectifier transistor, said first transistor, said second transistor, and said switch control unit are integrally integrated on one semiconductor substrate.

16. The control circuit according to claim 9, wherein said switching transistor, said synchronous rectifier transistor, said first transistor, said second transistor, and said switch control unit are integrally integrated on one semiconductor substrate.
